(19) United States
(12) Patent Application Publication
(10) Pub. No.: US 2014/0331870 A1
(43) Pub. Date: Nov. 13, 2014

(54) Peeling System And Peeling Machine For Peeling A Strand Of Food Product

(71) Applicant: Marel Meat Processing Inc., Des Moines, IA (US)

(72) Inventors: Gary H. Anders, Des Moines, IA (US); Ronald D. Bender, Ankeny, IA (US)

(73) Assignee: Marel Meat Processing Inc., Des Moines, IA (US)

(21) Appl. No.: 13/892,500

(22) Filed: May 13, 2013

(51) Int. Cl. A22C 11/00

(52) U.S. Cl. CPC A22C 11/003
USPC 99/443 C; 99/591; 99/588

(57) ABSTRACT

A peeling system and device that eliminates the need for a steam tube and/or air blasts by moving the position of a cutter blade or the use of a pincher wheel.

### BACKGROUND OF THE INVENTION

This invention is directed toward a peeling machine and more particularly a peeling machine that eliminates the need to use steam and/or air separation to peel a food product.

Peeling machines for food products are well known in the art. Typically, the process of peeling encased food product begins by stuffing meat emulsion into a continuous cellulose casing and then twisting the casing to form individual links on a strand of food product. The strand is then cooked in an oven and subsequently chilled, using a shower of cold water, to reduce the product temperature to acceptable packaging and storage levels, where the strands are manually fed into a peeling machine as a cold product.

The strand first enters a steam tube where the product is surrounded by steam to both hydrate and warm the cellulose casing causing expansion and separation from the surface of the cooked emulsion. As the strand is discharged from the steam tube, the strand is transported by a plurality of gripper wheels which propel the strand toward and past a cutter blade which is positioned adjacent and in-line with a rearward transport wheel. Shortly after the cutter blade makes a cut in the casing of the link, a blast of air from a nozzle connected to a source of compressed air hits the sliced casing to aid in opening the casing away from the surface of the food product.

Immediately after the cutter blade and air nozzle, the product is transported past a vacuum point where airflow is sucked down through a vacuum wheel, forcing the loose casing away from the product. The vacuum wheel, which rotates in the same direction as the product flows, strips the casing from the product as the product is discharged from the peeling machine and drops the spent casing into a hopper. The speed that the product is transported through the machine is sufficient to throw the product out of the machine and into a holding bin or take away conveyor for bulk removal. While the speed permits a high rate of throughput, the product becomes disoriented when discharged from the machine requiring reassembly or collating into a vacuum packaging machine for final packaging, requiring a separate loader. The product is also susceptible to damage from this process.

In addition, not only is the use of steam expensive, but steam may leak from the steam tube creating condensation that drips on the machine and food product. Presently, the condensation is wiped away manually. Also, due to exposure to the air in the plant, preservatives added to the food product are needed to maintain an acceptable shelf life. Thus, desired is a peeling device that addresses these deficiencies.

An objective of the present invention is to provide a peeling device that eliminates the need for steam.

A further objective of the present invention is to provide a peeling machine that eliminates the need for an air blast.

A still further objective of the present invention is to provide a peeling machine that controls a link after peeling for loading on a conveyor.

Another objective is to provide a peeling machine that reduces or eliminates the need for preservatives.

These and other objectives will be apparent to one of ordinary skill in the art based upon the following written description, drawings, and claims.

### SUMMARY OF THE INVENTION

A peeling system and machine wherein the peeling machine has a first set and a second set of transport wheels for transporting a strand of food product through a transport path formed between the transport wheels. A cutting blade is positioned adjacent the first set of transport wheels to cut a casing from the food product. At least one, and preferably two air nozzles are positioned to provide a blast of air to the cut casing to aid in the removal of the casing from the food product.

Alternatively, a pincher wheel having a groove with inwardly extending lips receives a cut food product from a cutter wheel. As the cut casing is pushed into the groove the lips aid in removing a cut casing from the food product. By controlling the peeled food product with the pincher wheel, the product can be deposited on a conveyor or loader for packaging.

### BRIEF DESCRIPTION OF THE DRAWINGS

FIG. 1 is a partial side view of a peeling machine;

FIG. 2 is an end view of a set of transport wheels for a peeling machine;

FIG. 3 is a side sectional view of a vacuum chamber;

FIG. 4 is a perspective view of a peeling machine;

FIG. 5A is a partial end view of a pincher wheel;

FIG. 5B is a partial end view of a pincher wheel;

FIG. 5C is a partial end view of a pincher wheel;

FIG. 5D is a partial end view of a pincher wheel;

FIG. 6 is a perspective view of a peeling machine;

FIG. 7 is a perspective view of a peeling machine;

FIG. 8 is a perspective view of a peeling machine;

FIG. 9 is a schematic view of a peeling system;

FIG. 10 is a perspective view of a decontamination system; and;

FIG. 11 is a perspective view of a peeling machine.

### DETAILED DESCRIPTION OF THE PREFERRED EMBODIMENTS

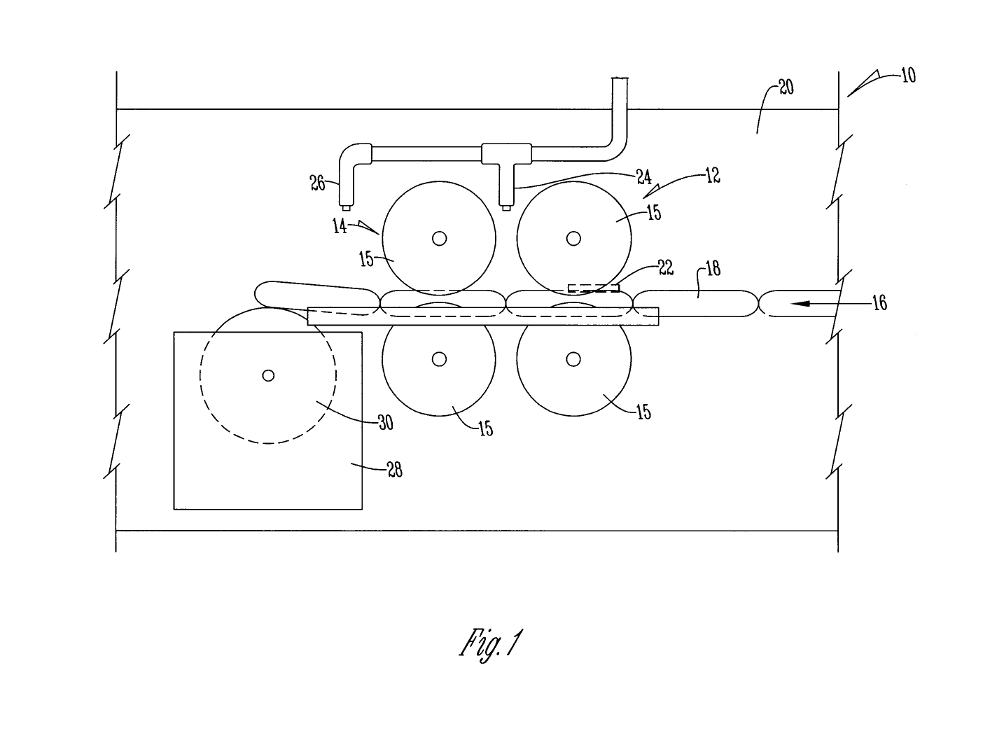

Referring to FIGS. 1-3, a peeling device 10 includes a first set 12 and second set 14 of transport wheels 15 that form a transport path 16 for a strand of food product 18. The transport wheels 15 are rotatably mounted to a frame 20 with preferably the top wheel of each set being an idler wheel and the bottom wheel of each set being driven by a motor (not shown). A cutting blade 22 is mounted to the frame 20 adjacent the first set 12 of transport wheels 15 such that the blade 22 engages and cuts the casing on a food product 18 before or as the food product 18 moves through the transport path 16.

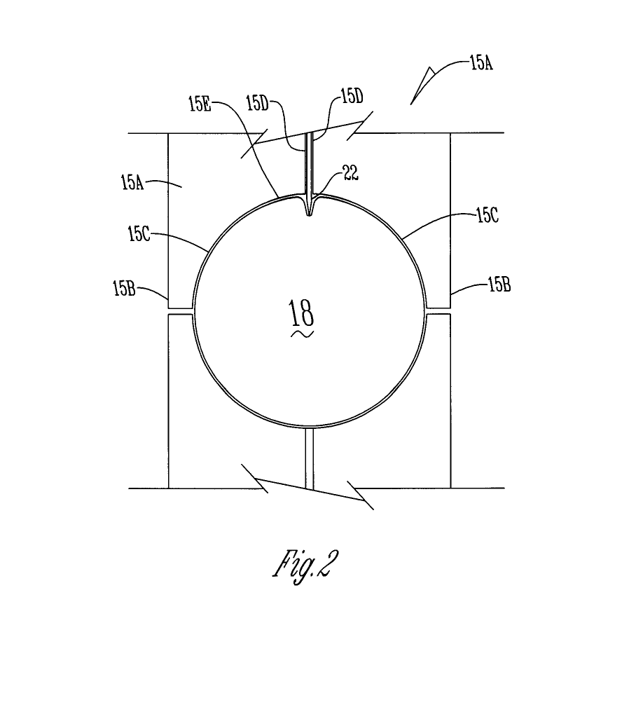

Alternatively, the cutting blade 22 is a floating blade 22 and is spring mounted to the frame 20 or is imbedded in a wheel 15. The imbedded blade 22, as shown in FIG. 2, is mounted to a central shaft 23 between a pair of half wheels 15A. The half wheels 15A have an outer edge 15B and an arcuate surface 15C that extends from the outer edge 15B to an inner edge 15D. When the half wheels 15A mounted such that the inner edges 15D are adjacent to one another, the arcuate surfaces 15C form a transport chamber 15E. The imbedded blade 22 extends beyond the arcuate surfaces 15C to engage the strand of food product 18 to cut the casing. As the food product 18 is transported through the transport chamber 15E, the outer edges 15B compress the food product 18 which stresses the casing making the casing easier to cut and reducing runs.

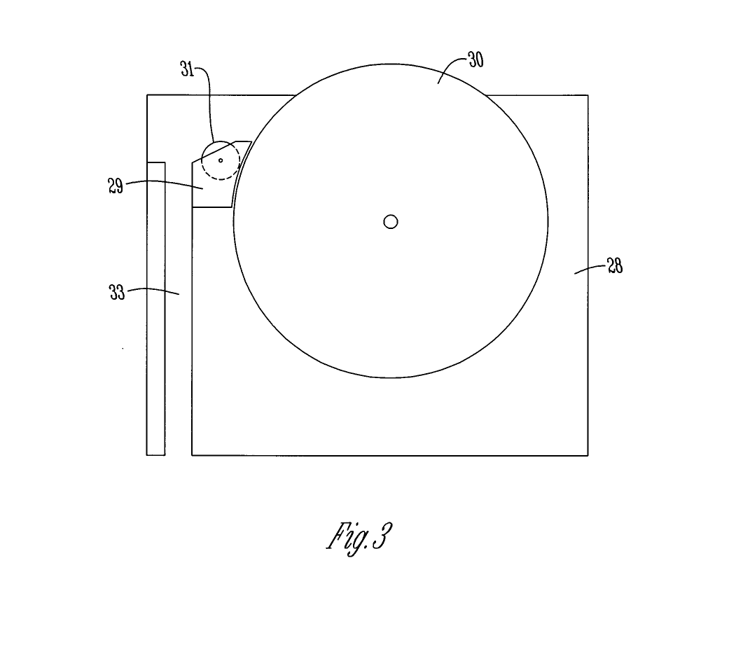

A first air nozzle 24 is mounted to the frame 20 and is positioned between the first set 12 and second set 14 of transport wheels 15. The first air nozzle 24, connected to a source of compressed air (not shown) provides a blast of air upon the cut casing to open and separate the casing from the cooked food product 18. A second air nozzle 26 is mounted to the frame 20 downstream of the transport wheels 15. Preferably, the second nozzle 26 is positioned above a vacuum chamber 28 that may or may not include a vacuum wheel 30 rotatably mounted within the chamber 28. The second air nozzle 26, connected to a source of compressed air (not shown) aids in opening the casing away from the surface of the food product 18. The casing is then vacuumed into chamber 28 and transported away by vacuum wheel 30 while the food product 18 is discharged from the machine 10. For example, in one embodiment, as shown in FIG. 3, the vacuum chamber 28 has a vacuum wheel 30 with a shoe 29 mounted adjacent the vacuum wheel 30 and a second wheel 31 mounted adjacent shoe 29. After the air blast from the second nozzle 26, the vacuum wheel 30 captures the cut casing and transports the casing toward a vacuum tube 33. The shoe 29 shucks the casing from the vacuum wheel 30 where the second wheel 31 transports the cut casing to the vacuum tube 33. Alternatively, after the second blast from nozzle 26, the vacuum tube 33 has a sufficient suction to capture the cut casing.

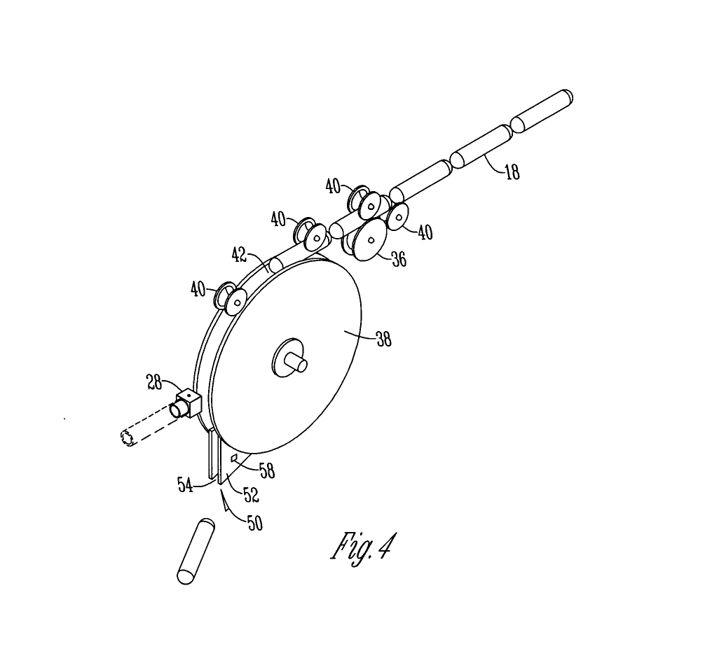

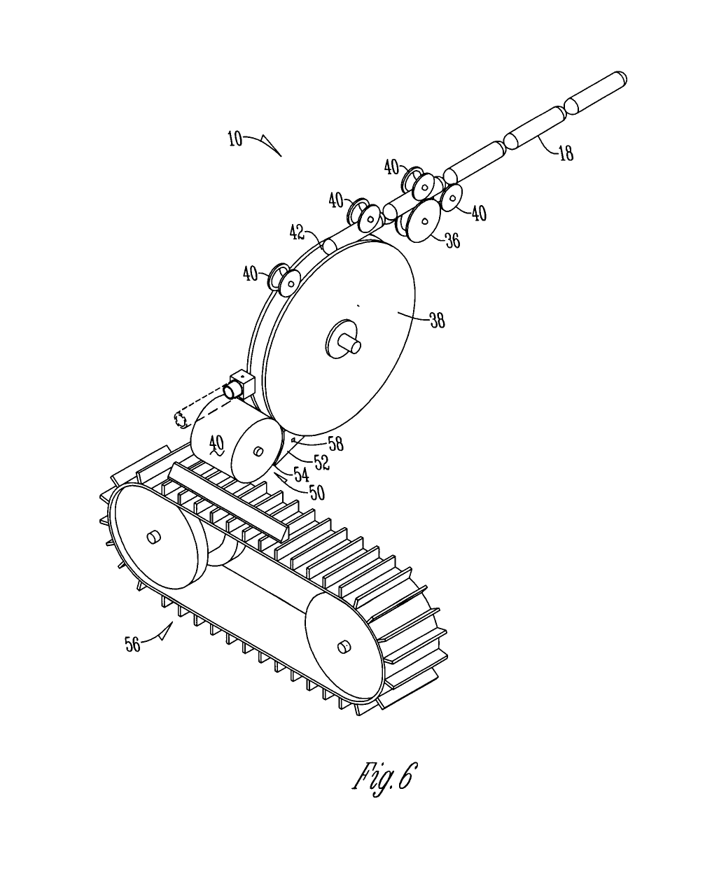

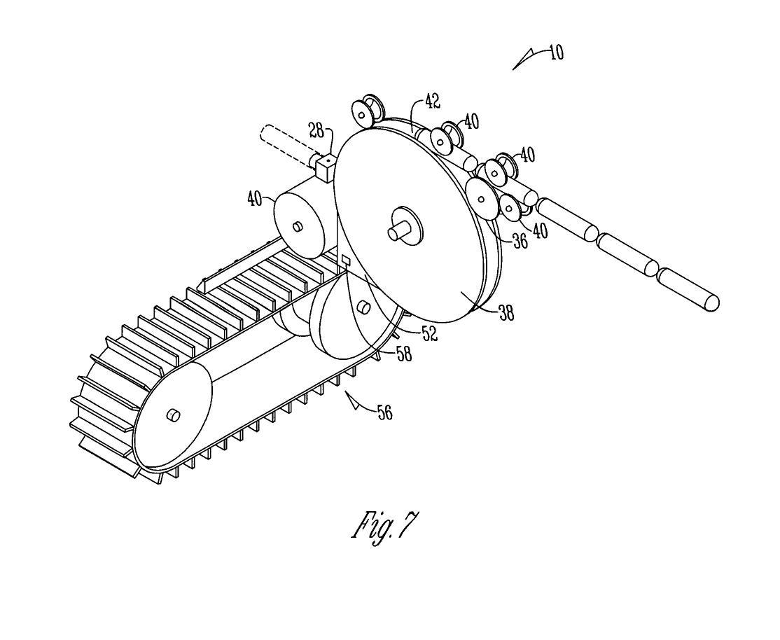

In an alternative embodiment, as shown in FIGS. 4-8, the transport wheels 15 are replaced by a cutting wheel 36 and a pincher wheel 38. The transport path 16 is formed between a plurality of rollers 40 and the cutting wheel 36 and the pincher wheel 38 which are all rotatably mounted to the frame 20. The cutting blade 22, as previously described, is fixed to the frame, floating, or imbedded in the cutting wheel 36.

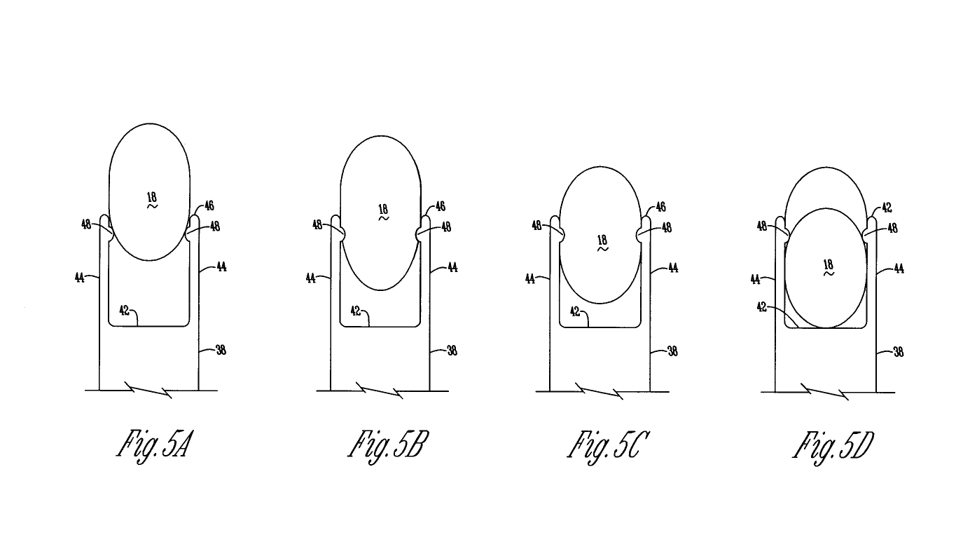

The pincher wheel 38, as shown in FIGS. 5A-5B has a groove 42 formed about its outer periphery by a pair of flanges 44 that extend outwardly. At the outer edge 46 of the flange 44 are a pair of inwardly extending lips 48. The lips 48 pinch the food product 18 as the food product 18 is pushed into groove 42, which causes the casing to be separated and vacuumed away. The flanges 44 are adjustable and may be moved toward and away from one another to accommodate products of different diameter.

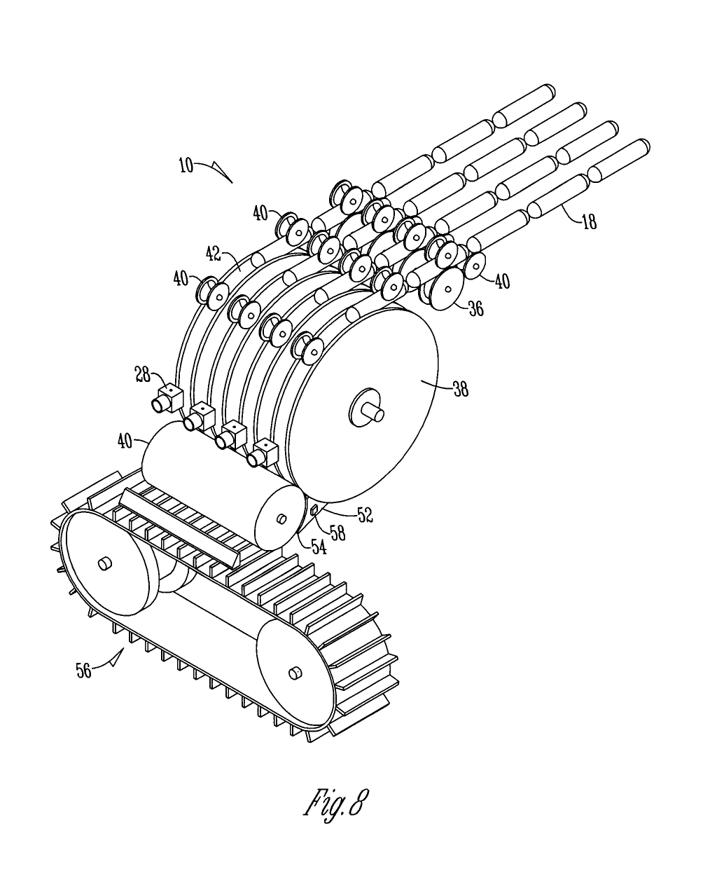

Mounted to the frame 20 at the discharge point 50 of the pincher wheel 38 is an ejection shoe 52. The ejection shoe 52 has a groove 54 around its outer periphery that is in-line and in communication with groove 42 of the pincher wheel 38. The ejection shoe 52 receives the peeled food product 18 from the pincher wheel 38 and maintains the food product's 18 orientation as the food product is transported to a conveyor or loader 56. The rotational speed and/or positioning of a buffer on the conveyor 56 is adjusted based upon the detection of the food product 18 by a proximity sensor 58 or the like which detects when the product 18 is ready for deposit. Alternatively, alignment of the loader 56 is based on the sensed spacing of the food product. A single cutting wheel 36 and pincher wheel 38 assembly may be used or multiple assemblies in parallel spaced relation may be used as shown in FIG. 8. The use of multiple assemblies permits food product 18 to be transferred to the loader at a slower rotational speed of the assemblies.

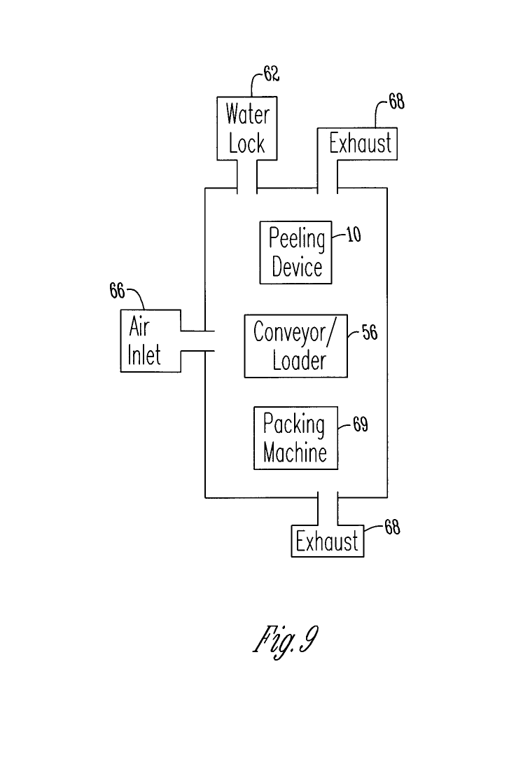

Preferably, as shown in FIG. 9, the machine 10 and loader 56 are enclosed within a sealed housing 60. The housing 60 has a water lock 62 such as a spray or dip at the product inlet 64 of the housing 60. The housing also has an air inlet 66 that receives pressurized air to prevent outside air from entering the housing, and at least one exhaust 68.

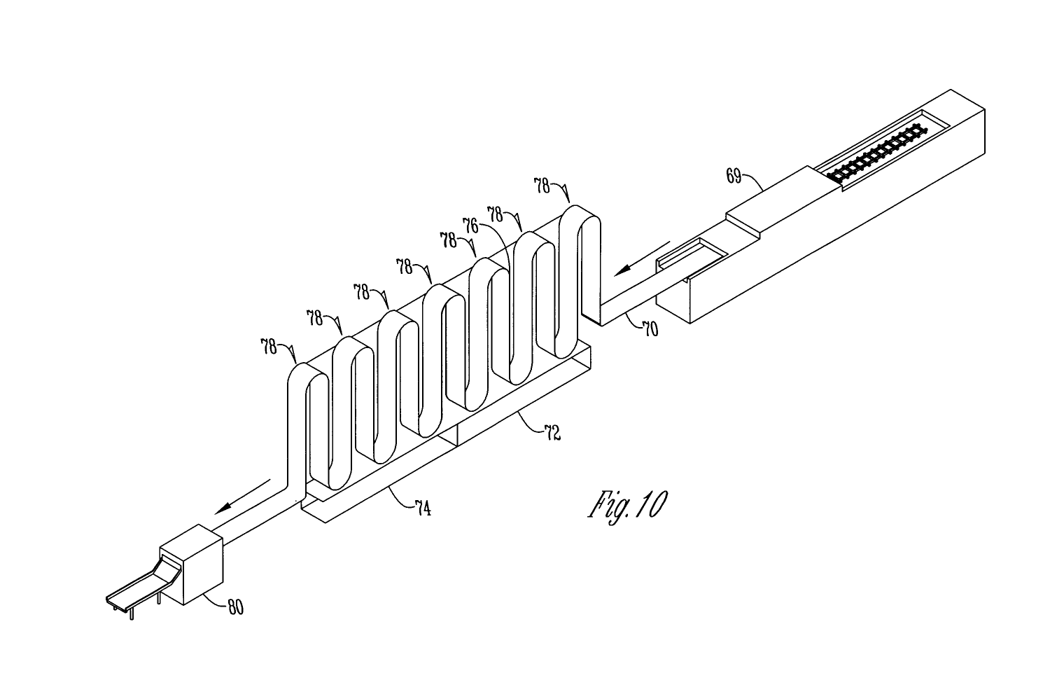

Once packaged, as shown in FIG. 10, instead of cutting into individual packs, the packaged food products 18 exit the packaging machine 69 as a continuous web 70 through a water cooker 72 and subsequent chiller 74. Alternatively, hot air or a microwave is used. Preferably, the web 70 is transported on a continuous serpentine conveyor 76 through cooker 72 and chiller 74 such that all product has surface exposure instead of being shielded by a pile of packs which reduces cooking/chilling times. The cooker 72 and a chiller 74 have a plurality of inlets 78 that allow for different flow streams across product 18 on the conveyor 76 so that heat transfer may be maximized. Upon exiting the chiller 74, the web 70 is transported to a web cutting station 80 or stacker where the web 70 is cut into individual packs. This process improves the appearance of the packaging as the edges do not curl, the product cooks better due to greater exposure, and because of the serpentine arrangement, a smaller footprint is needed for the unit.

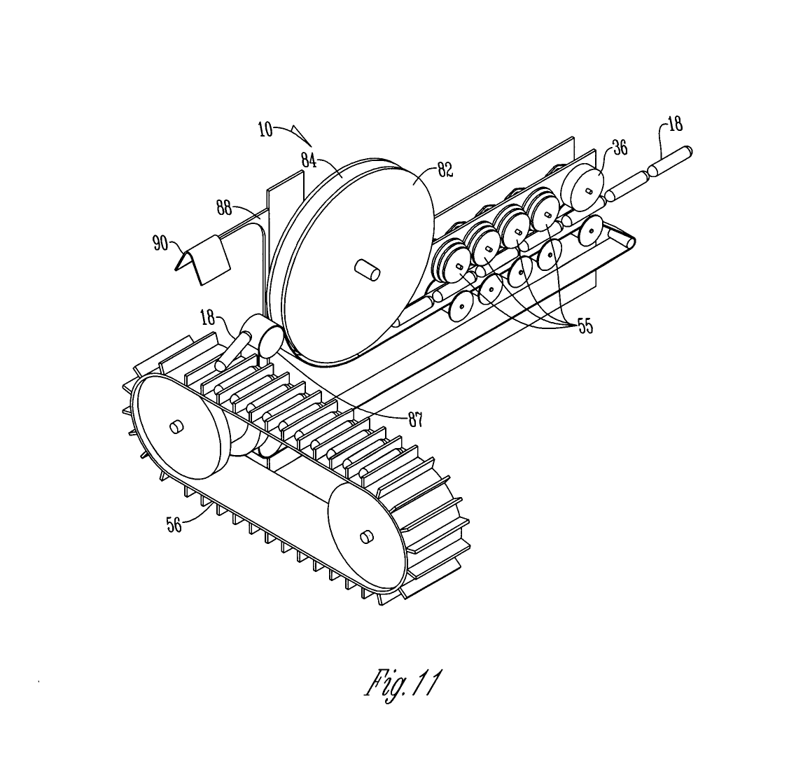

In yet another embodiment, as shown in FIG. 11, a plurality of transport wheels 15 are rotatably mounted to a frame 20 with the first set 12 of transport wheels 15 have a cutting blade 22 mounted to the frame 20 therebetween. Positioned downstream of the transport wheels 15 is a shuck wheel 82 having a groove 84 that extends around the outer edge 86 of shuck wheel 82 to capture the cut food product 18. The captured food product 18 is transported around shuck wheel 82 so as to engage a casing separator brush 87 that is mounted to the frame 20 and downstream of shuck wheel 82. Brush 87 aids in separating the cut casing from the food product 18. The peeled food product 18 is then transported along guide member 88 to an orientation shield 90 where the peeled food product is deposited onto a loader 56.

Thus, a peeler machine has been disclosed that at the very least meets the stated objectives. The use of steam is eliminated in part by moving the cutting blade to the first set of transport wheels. The use of air blasts has been eliminated in part by the use of a pincher wheel. The pincher wheel, along with the ejection shoe, control the peeled food product for delivery to a conveyor/loader. Finally, the sealed housing provides a sterile environment for peeling and reducing the need for preservatives.

What is claimed is:

1. A peeling making for removing a casing from a strand of food product, comprising:
a plurality of transport wheels rotatably mounted to a frame and forming a transport path for the strand of food product therebetween;
a cutting blade mounted to the frame and positioned between a first set of transport wheels so as to cut the transported food product; and
a first air nozzle mounted to the frame between the first set of transport wheels and a second set of transport wheels to provide a blast of compressed air to the cut food product.

2. The peeling machine of claim 1 further comprising a second air nozzle mounted to the frame downstream of the second set of transport wheels to provide a second blast of compressed air to the cut food product.

3. The peeling machine of claim 1 wherein the transport wheels have a groove around the wheel's outer perimeter that receives the food product and pushes the food product inward.

4. A peeling machine for removing a casing from a strand of food product, comprising:
a cutting wheel rotatably mounted to a frame;
a cutting blade mounted to the frame adjacent the cutting wheel;
a pincher wheel rotatably mounted to the frame having a groove that extends around the outer edge of the pincher wheel formed by two outwardly extending flanges; and
a pair of lips extending inwardly from the flanges.

5. The peeling device of claim 4 further comprising a plurality of rollers rotatably mounted to the frame and positioned in relation to the cutting wheel and the pincher wheel to form a transport path for the strand of food product.

6. The peeler machine of claim 4 further comprising an ejection shoe mounted to the frame adjacent a discharge point of the position wheel wherein the ejection shoe has a groove aligned with the groove of the pincher wheel.

7. The peeler machine of claim 6 wherein a conveyor receives peeled food product from the ejection shoe.

8. The peeler machine of claim 7 wherein a position and a rotational speed of the conveyor are determined based upon the detection of the peeled food product ready for deposit upon the conveyor.

9. A peeler system for removing a casing from a strand of food product, comprising:
a peeling machine and a conveyor enclosed within a housing;
a water lock positioned at a product entrance to a housing;
an air inlet on the housing that provides pressurized air to the interior of the housing; and
at least one exhaust on the housing.

10. A post decontamination system for packaged food products Comprising:
a conveyor that transports a web of packaged food product through a cooking tank and adjacent chilling tank;
wherein the conveyor is serpentined and
a web cutting station downstream of the chilling tank.

11. The system of claim 10 wherein the cooking and chilling tanks have a plurality of water inlets where the flow of each inlet is set independently.
